(19) United States
(12) Patent Application Publication
(10) Pub. No.: US 2014/0234053 A1
(43) Pub. Date: Aug. 21, 2014

(54) ELASTIC FASTENERS

(71) Applicant: David Martin, Saegertown, PA (US)

(72) Inventor: David Martin, Saegertown, PA (US)

(21) Appl. No.: 14/185,591

(22) Filed: Feb. 20, 2014

Related U.S. Application Data
(60) Provisional application No. 61/767,085, filed on Feb. 20, 2013.

(51) Int. Cl. F16B 19/00

(52) U.S. Cl. CPC F16B 19/002
USPC 411/508; 29/525.01

(57) ABSTRACT

Elastic fasteners for fastening, securing or otherwise holding objects together are disclosed. The elastic fasteners include a head, an elastic shaft, and a retainer clip. The retainer clip includes a slot having a width that is smaller than the diameter of the elastic shaft. The end of the elastic shaft may be pulled to thereby stretch the elastic shaft and to decrease its diameter, allowing the retainer clip to be installed on the elastic shaft by inserting the stretched elastic shaft into the slot of the retainer clip. After the retainer clip is installed on the stretched elastic shaft, the end of the elastic shaft may be released to unstretch the elastic shaft and increase its diameter, thereby engaging in the slot of the retainer clip.

### CROSS-REFERENCE TO RELATED APPLICATION

This application claims the benefit of U.S. Provisional Patent Application Ser. No. 61/767,085 filed Feb. 20, 2013, which is incorporated herein by reference.

### FIELD OF THE INVENTION

The present invention relates to fasteners, and more particularly relates to elastic fasteners.

### BACKGROUND INFORMATION

It is often necessary to secure objects together. Mechanical fasteners such as bolts, pins, clamps, straps and the like have conventionally been used for fastening purposes. However, such mechanical fasteners can be cumbersome and/or time-consuming to use.

### SUMMARY OF THE INVENTION

The present invention provides elastic fasteners for fastening, securing, or otherwise holding objects together. There are many uses for such elastic fasteners, including bathroom fixtures, toilet seats, toilet tanks, sporting applications, automobiles, all terrain vehicles, utility terrain vehicles, wood, steel, plastic, business, home, office, manufacturing, farming, industrial applications and other applications.

An aspect of the present invention is to provide a fastener comprising: a head; an elastic shaft comprising an elastomeric material connected to the head having a first diameter when the elastic shaft is unstretched and a second diameter when the elastic shaft is stretched, wherein the second diameter is less than the first diameter; and a retainer clip comprising a slot having a width that is smaller than the first diameter of the elastic shaft, wherein the slot is structured and arranged to receive the elastic shaft when the elastic shaft is stretched, and to securingly engage the elastic shaft when at least a portion of the elastic shaft is unstretched.

Another aspect of the present invention is to provide a fastened assembly comprising a first article, a second article, and an elastic fastener securing the first and second articles together. The elastic fastener comprises: a head engaging the first article; an elastic shaft comprising an elastomeric material connected to the head having a first diameter when the elastic shaft is unstretched and a second diameter when the elastic shaft is stretched, wherein the second diameter is less than the first diameter; and a retainer clip engaging the second article comprising a slot having a width that is smaller than the first diameter of the elastic shaft, wherein a portion of the elastic shaft is securingly engaged in the slot of the retainer clip.

A further aspect of the present invention is to provide a method of fastening articles together. The method comprises: positioning a head of an elastic fastener adjacent to a first article; passing an elastic shaft of the elastic fastener through at least a portion of a second article; pulling an end of the elastic shaft to thereby stretch and reduce the diameter of the elastic shaft; placing a retainer clip on the stretched elastic shaft by sliding a portion of the stretched elastic shaft into a slot of the retainer clip; and releasing the end of the elastic shaft to thereby unstretch and increase the diameter of a portion of the elastic shaft, securingly engage a portion of the elastic shaft with the retainer clip, and press the retainer clip against the second article.

These and other aspects of the present invention will be more apparent from the following description.

### BRIEF DESCRIPTION OF THE DRAWINGS

FIG. 1 is a side view illustrating an elastic shaft and head of an elastic fastener in accordance with an embodiment of the present invention.

FIG. 2 is a front view of a retainer clip of an elastic fastener in accordance with an embodiment of the present invention.

FIGS. 3-5 are partially schematic side views illustrating the use of an elastic fastener to secure two articles together in accordance with an embodiment of the present invention. In FIG. 3, the elastic shaft of the fastener is unstretched and passes through holes in the articles to be fastened together. In FIG. 4, the elastic shaft is stretched and a retainer clip is placed on the stretched elastic shaft. In FIG. 5, the end of the elastic shaft is released and a portion of the shaft engages the retainer clip to thereby fasten the articles together between the retainer clip and the head of the elastic fastener.

FIGS. 6-10 are partially schematic side sectional views of elastic fasteners in accordance with embodiments of the present invention.

### DETAILED DESCRIPTION

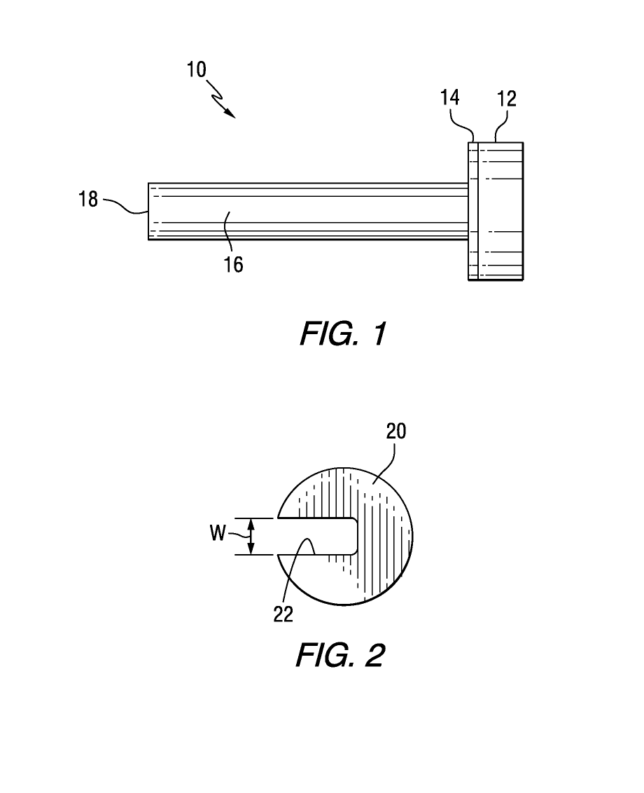

FIGS. 1 and 2 illustrate components of an elastic fastener 10 in accordance with an embodiment of the present invention. The elastic fastener 10 includes a head 12 and an elastic shaft 16 having an end 18 opposite from the head 12. The head 12 and elastic shaft 16 may be made of any suitable elastomeric material, for example, natural rubber, synthetic rubber, and elastomeric polymers. Some specific examples include thermoplastic elastomers, thermoplastic olefins, thermoplastic polyurethane and other materials having elastic characteristics. The head 12 and elastic shaft 16 may be integrally formed from the same type of elastomeric material. Alternatively, at least a portion of the head 12 may be made from a different type of elastomeric or non-elastomeric material. In the embodiment shown, the elastic fastener 10 includes a washer 14 adjacent to the head 12 surrounding the elastic shaft 16.

As shown in FIG. 2, the elastic fastener includes a retainer clip 20 having a retaining slot 22 therein. The retaining slot 22 has a width W. As more fully described below, the width W of the slot 22 is smaller than the diameter of the elastic shaft 16 when the elastic shaft 16 is in an unstretched condition. In the embodiment shown, the retainer clip 20 and slot 22 form a generally C-shaped configuration.

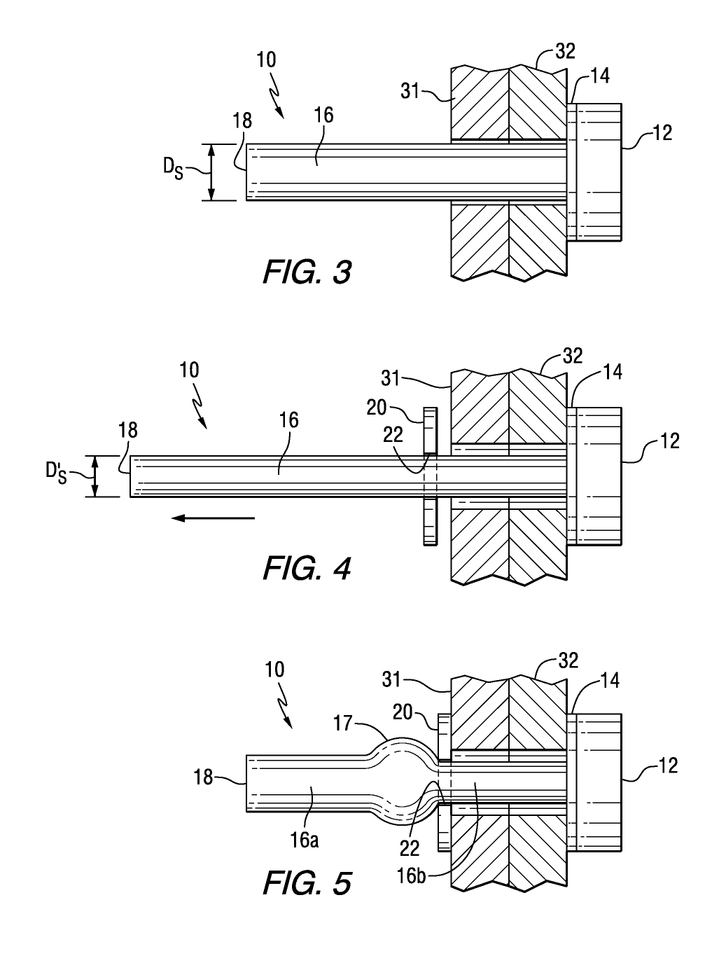

FIGS. 3-5 illustrate sequential steps for fastening articles together using the elastic fastener 10. In FIG. 3, the elastic shaft 16 of the elastic fastener 10 is inserted through holes in two articles 31 and 32 that are to be fastened together. The elastic shaft 16 is inserted through the holes of the articles 31 and 32 until the head 12 and washer 14 of the fastener 10 are seated against a surface of the article 32. The elastic shaft 16 is in an unstretched condition in FIG. 3 and has a diameter D_{S}.

In FIG. 4, the end 18 of the elastic shaft 16 is pulled in the direction of the arrow to thereby stretch the elastic shaft 16. In the stretched condition shown in FIG. 4, the stretched elastic shaft 16 has a longer axial length than the unstretched elastic shaft 16 shown in FIG. 3, and the diameter D′_{S} of the stretched elastic shaft 16 as shown in FIG. 4 is smaller than the diameter D_{S} of the unstretched elastic shaft 16 as shown in FIG. 3. The stretched elastic shaft 16 with its reduced diameter D′_{S} shown in FIG. 4 enables the slot 22 of the retainer clip 20 to receive the reduced-diameter stretched elastic shaft 16. During use, the end 18 of the elastic shaft 16 may be pulled a sufficient distance such that the diameter D_{S} of the unstretched elastic shaft is at least 2 percent greater than the diameter D′_{S} of the stretched elastic shaft. For example, D_{S} may be at least 5 or 10 percent greater than D′_{S}.

The width W of the retaining slot 22 may be greater than or equal to the diameter D′_{S} of the stretched elastic shaft 16, but is less than the diameter D_{S} of the unstretched elastic shaft 16. The width W of the slot may typically be at least 1 percent less than the diameter D_{S} of the unstretched elastic shaft 16, for example, W may be at least 5 or 10 percent less than D_{S}. Depending on the desired application of an elastic fastener, differing sizes of retainer clips and slots may be used. For example, given multiple applications for the same sized elastic fastener, retainer clips with smaller slots may be used in applications where higher holding tensions are required, and retainer clips with larger slots may be used in applications where lower holding tensions are required.

In certain embodiments, the end 18 of the elastic shaft 16 may be pulled by hand into the stretched position shown in FIG. 4, and the retainer clip 20 may be installed on the stretched elastic shaft 16 by hand as well. Alternatively, any suitable type of hand tool or other tool may be used to pull the end 18 of the elastic shaft 16 and/or place the retainer clip 20 onto the stretched elastic shaft 16.

In FIG. 5, the end 18 of the elastic shaft 16 has been released, thereby causing at least a portion of the elastic shaft 16a to retract toward the head 12 of the elastic fastener 10. Such release of the end 18 of the elastic shaft 16 and its retraction toward the head 12 causes the diameter of a portion of the elastic shaft 16a to return to its original unstretched diameter D_{S}. However, in the region of the elastic shaft 16 near the retainer clip 20, the radial expansion of the retracted elastic shaft 16 causes that portion of the elastic shaft 16 to contact the slot 22 of the retainer clip 20 and may form a bulge 17 in a portion of the elastic shaft 16 that is too large to be drawn through the slot 22 of the retainer clip 20. The bulged portion 17 of the elastic shaft 16 acts to press the retainer clip 20 against the surface of the article 31. In this configuration, the portion of the elastic shaft 16b between the retainer clip 20 and head 12 of the elastic fastener 10 is still in a stretched condition, which forces the articles 31 and 32 together due to the tension provided by the elastic material of the stretched portion 16b of the elastic shaft 16.

In the embodiment shown in FIGS. 3-5, the end 18 of the elastic shaft 16 has a flat end surface and the region of the elastic shaft 16 adjacent to the end 18 is generally cylindrical. However, the end 18 may have any other suitable shape that may facilitate operation of the fastener. For example, the end 18 may comprise a flattened portion of the elastic shaft 16 (not shown) that may enable a user to get a better finger or hand grip on the fastener, or to provide improved engagement with a gripping tool (not shown), when the elastic shaft 16 is pulled to its stretched position as shown in FIG. 4. In addition to a flattened end, any other suitable configuration may be used, including holes, hooks, loops, straps, or any other shape or structure at or near the end 18 to facilitate gripping and stretching of the elastic shaft 16. Such structures may be integrally formed from the same elastomeric material of the elastic shaft 16, or may be made of other materials such as a metal or plastic end cap or tab (not shown). In certain embodiments, the end 18 of the elastic shaft 16 remains as part of the fastener 10 after it is installed. However, in other embodiments, the end 18 may be cut to a desired length or otherwise removed if desired.

In accordance with the present invention, the elastic fasteners may be used to secure many different types of articles together. While examples of two articles 31 and 32 with aligned holes are schematically shown in FIGS. 3-5, many different types of articles may be secured together in accordance with embodiments of the present invention. For example, instead of holes, one or both of the articles may have slots, edges, notches or other types of features that permit engagement with the head 12, elastic shaft 16 and retainer clip 20 of the elastic fasteners. Furthermore, the shape and configuration of the retaining slot 22 in the retainer clip 20 may be modified. For example, the slot may have an open configuration as shown in FIG. 2, or may have a closed configuration in which the slot does not extend to the peripheral edge of the retainer clip 20. In the case of a closed slot, the retainer clip may be installed on the elastic shaft 16 by sliding the retainer clip over the end 18 of the elastic shaft, e.g., before or after the elastic shaft 16 is stretched. Such a closed slot may have any suitable shape, such as round, elongated, or the like.

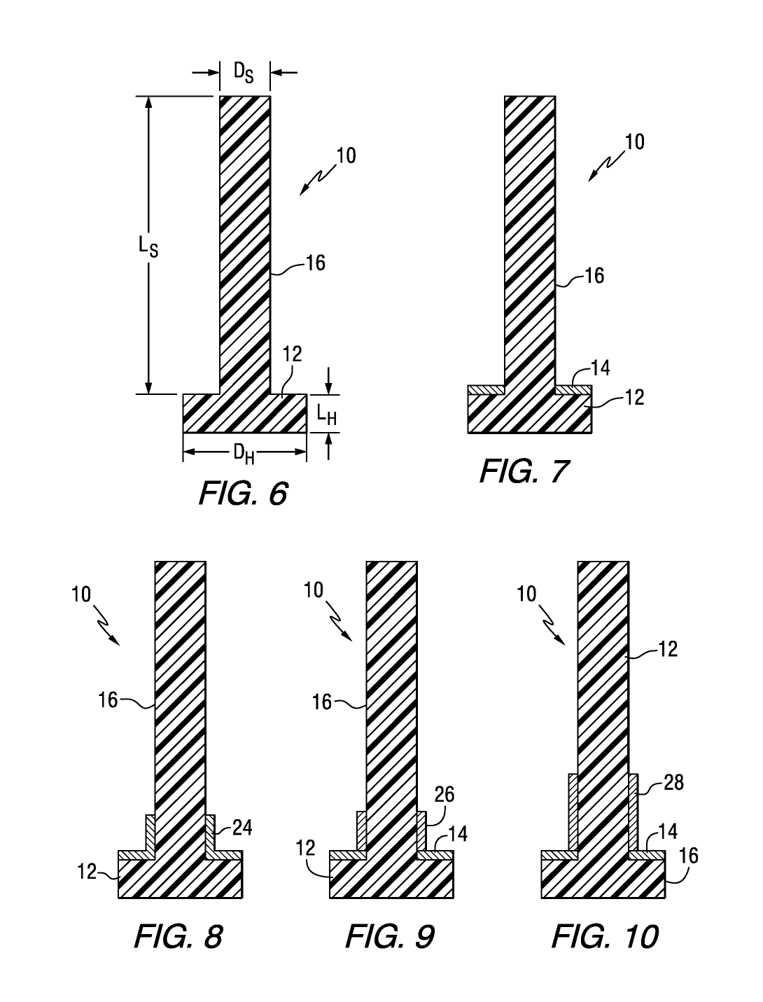

FIGS. 6-10 are partially schematic side sectional views of elastic fasteners 10 in accordance with embodiments of the present invention. In the embodiment shown in FIG. 6, the elastic fastener 10 does not include a washer adjacent to the head 12 of the fastener. The head 12 of the fastener 10 has a length L_{H} and a diameter D_{H}. The unstretched elastic shaft 16 of the fastener 10 has a length L_{S} and a diameter D_{S}. Although the terms D_{S} and D_{H} are referred to as diameters herein, it is to be understood that the cross-sectional shapes of the shaft and head may be of any suitable configuration including round, square, hexagonal, octagonal, oval, and the like. For shafts or heads having non-circular cross-sections, the diameters thereof are measured across the smallest dimensional width thereof. For example, the diameter of a square or hexagonal shaft is measured as the distance between opposing flat sides of the square or hexagon.

The diameter D_{S} of the unstretched elastic shaft 16 may typically be from 0.1 inch to 2 inches or greater, for example, from 0.2 to 1 inch, or from 0.25 to 0.75 inch. The length L_{S} of the unstretched elastic shaft 16 may typically be from 1 to 6 inches or more, for example, from 2 to 5 inches. However, any suitable length may be used. The diameter D_{H} of the head 12 may be larger than the diameter D_{S}, and may be selected by the particular application or objects or surfaces to be fastened. For example, the diameter D_{H} of the head 12 may be at least 10 percent, or 20 percent, or 30 percent greater than the diameter Dₛ of the elastic shaft. In certain embodiments, the diameter D_{H} of the head 12 may be from 0.2 to 2.5 inches, or from 0.25 to 1 inch. The length L_{H} of the head 12 may typically be from 0.1 to 0.75 inch, for example, from 0.125 to 0.5 inch.

As described above, the width W of the retaining slot 22 of the retainer clip 20 is less than the diameter D_{S} of the unstretched elastic shaft 16. The width W of the slot may typically range from 0.09 inch to 1.8 inches, for example, from 0.18 to 0.8 inch, or from 0.2 to 0.7 inch, depending on the diameter D_{S} of the unstretched elastic shaft 16.

In the embodiment shown in FIG. 7, the elastic fastener 10 includes a washer 14 adjacent to the head 12 of the fastener and surrounding a portion of the elastic shaft 16 of the fastener. The washer 14 may be round, square, hexagonal, octagonal, oval or any other suitable shape. The washer 14 may be provided in any suitable size, depending on the application, and may have a central opening or slot having a typical diameter of from 0.1 to 1 inch, which may be approximately the same or similar to the diameter D_{S} of the unstretched elastic shaft 16.

In the embodiment shown in FIG. 8, the elastic fastener 10 includes an integral flange 24 adjacent to the head 12 of the fastener and surrounding a portion of the elastic shaft 16 of the fastener. The sleeve portion of the integral flange 24 may help protect the elastic shaft 16.

In the embodiment shown in FIG. 9, the elastic fastener 10 includes a washer 14 and a separate sleeve 26 adjacent to the head 12 of the fastener and surrounding portions of the elastic shaft 16 of the fastener. In this embodiment, the short sleeve 26 may be added or removed in order to accommodate a particular application or utility for the elastic fastener, e.g., to provide protection for the elastic shaft 16. Additionally, such a short sleeve 26 may provide a surface which is lubricated or otherwise more slidably movable in relation to an object or surface to be fastened than the elastomeric material of the elastic shaft 16. For example, in applications wherein the elastic fastener may be placed into a hinge. Such a short sleeve 26 may vary in length, typically from 10 to 25 percent of the length L_{S} of the unstretched elastic shaft 16.

In the embodiment shown in FIG. 10, the elastic fastener 10 includes a washer 14 and a separate sleeve 28 having a relatively long axial length adjacent to the head 12 of the fastener and surrounding portions of the elastic shaft 16 of the fastener. The relatively long sleeve 28 may have a length of from 25 to 90 percent of the length L_{S} of the unstretched elastic shaft 16. The long sleeve 28 may be added or removed in order to accommodate a particular application or utility for the elastic fastener, or to provide additional protection for the elastic shaft 16. Additionally, the sleeve 28 may provide a surface which is lubricated or otherwise more slidably movable in relation to an object or surface to be fastened than the elastomeric material of the elastic shaft 16, for example in applications wherein the elastic fastener may be placed into a hinge.

In the embodiments shown in FIGS. 7-10, the washer 14, integral flange 24, and sleeves 26 and 28, may be made of any suitable material such as metal, plastic or other durable materials. Such materials may provide a hard abutment or durable surface for the object, surface, or material to be fastened, and are generally less elastic or deformable than the elastomeric material of the elastic shaft 16. In such embodiments, the integral flange 24, and sleeves 26 and 28 may be used to provide a hard abutment or durable surface around the circumference of the lower portion of the elastic shaft 16.

Although certain structural features and dimensions of the elastic fasteners are described herein, it is to be understood that other configurations and dimensions may be used depending on the particular use or application of the fasteners, and such modifications would be evident to those skilled in the art.

Whereas particular embodiments of this invention have been described above for purposes of illustration, it will be evident to those skilled in the art that numerous variations of the details of the present invention may be made without departing from the invention as defined in the appended claims.

What is claimed is:

1. A fastener comprising:
a head;
an elastic shaft comprising an elastomeric material connected to the head having a first diameter when the elastic shaft is unstretched and a second diameter when the elastic shaft is stretched, wherein the second diameter is less than the first diameter; and
a retainer clip comprising a slot having a width that is smaller than the first diameter of the elastic shaft, wherein the slot is structured and arranged to receive the elastic shaft when the elastic shaft is stretched, and to securingly engage the elastic shaft when at least a portion of the elastic shaft is unstretched.

2. The fastener of claim 1, wherein the first diameter of the unstretched elastic shaft is at least 5 percent greater than the second diameter of the stretched elastic shaft.

3. The fastener of claim 1, wherein the first diameter of the unstretched elastic shaft is at least 10 percent greater than the second diameter of the stretched elastic shaft.

4. The fastener of claim 1, wherein the width of the slot of the retainer clip is at least 2 percent smaller than the first diameter of the unstretched elastic shaft.

5. The fastener of claim 1, wherein the width of the slot of the retainer clip is at least 5 percent smaller than the first diameter of the unstretched elastic shaft.

6. The fastener of claim 1, wherein the slot of the retainer clip comprises substantially flat opposing sidewalls extending in a parallel direction from a central portion of the retainer clip to a peripheral edge of the retainer clip.

7. The fastener of claim 1, wherein the retainer clip is generally C-shaped.

8. The fastener of claim 1, wherein the retainer clip comprises a circular peripheral edge.

9. The fastener of claim 1, wherein the elastomeric material of the elastic shaft comprises natural rubber and/or synthetic rubber.

10. The fastener of claim 1, wherein the elastomeric material of the elastic shaft comprises a thermoplastic polymer.

11. The fastener of claim 1, wherein the head has a diameter at least 10 percent greater than the first diameter of the unstretched elastic shaft.

12. The fastener of claim 1, wherein the head has a diameter at least 25 percent greater than the first diameter of the unstretched elastic shaft.

13. The fastener of claim 1, further comprising a washer contacting the head and surrounding a portion of the elastic shaft.

14. The fastener of claim 13, further comprising a sleeve connected to the washer and surrounding another portion of the shaft.

15. A fastened assembly comprising a first article, a second article, and an elastic fastener securing the first and second articles together, the elastic fastener comprising:
a head engaging the first article;
an elastic shaft comprising an elastomeric material connected to the head having a first diameter when the elastic shaft is unstretched and a second diameter when the elastic shaft is stretched, wherein the second diameter is less than the first diameter; and
a retainer clip engaging the second article comprising a slot having a width that is smaller than the first diameter of the elastic shaft, wherein a portion of the elastic shaft is securingly engaged in the slot of the retainer clip.

16. The assembly of claim 15, wherein the first and second articles are releasably secured together by the elastic fastener.

17. The assembly of claim 15, wherein the elastic shaft comprises an unstretched portion adjacent an end of the elastic shaft and a stretched portion extending between the retainer clip and the head of the elastic fastener.

18. A method of fastening articles together comprising:
positioning a head of an elastic fastener adjacent to a first article;
passing an elastic shaft of the elastic fastener through at least a portion of a second article;
pulling an end of the elastic shaft to thereby stretch and reduce the diameter of the elastic shaft;
placing a retainer clip on the stretched elastic shaft by sliding a portion of the stretched elastic shaft into a slot of the retainer clip; and
releasing the end of the elastic shaft to thereby unstretch and increase the diameter of a portion of the elastic shaft, securingly engage a portion of the elastic shaft with the retainer clip, and press the retainer clip against the second article.
